(19) United States
(12) Patent Application Publication
(10) Pub. No.: US 2025/0272649 A1
(43) Pub. Date: Aug. 28, 2025

(54) SYSTEM AND METHOD TO OPTIMIZE ROUTING OF PARCELS

(71) Applicant: ConData Global, Inc., Oak Brook, IL (US)

(72) Inventor: Nikhil Deshpande, Chicago, IL (US)

(21) Appl. No.: 19/064,119

(22) Filed: Feb. 26, 2025

Related U.S. Application Data
(60) Provisional application No. 63/557,965, filed on Feb. 26, 2024.

(51) Int. Cl. G06Q 10/0835; G06Q 10/047

(52) U.S. Cl. CPC G06Q 10/08355; G06Q 10/047

(57) ABSTRACT

A system and method to optimize routing of a plurality of shipments is disclosed. Shipment data associated with the plurality of shipments is received, wherein the shipment data includes at least an originating postal code and a destination postal code associated with each shipment. A plurality of departure airports associated with each originating postal code and a plurality of destination airports associated with each destination postal code are identified. A first plurality of routes associated with the plurality of shipments is developed, wherein each route is associated with a departure airport and a destination airport. A plurality of shipment counts is developed, wherein each shipment count of the plurality of shipment counts is associated with a departure airport of the plurality of airports and indicates a quantity of the plurality routes that are associated with the departure airport. A shipment from the plurality of shipments is selected, a plurality of candidate routes that may be used for the shipment is selected from the plurality of routes, and a route of the plurality of candidate routes associated with a departure airport having highest shipment count associated therewith is selected and assigned to the shipment.

### CROSS-REFRERENCE TO RELATED APPLICATIONS

The present application claims the benefit of priority of Deshpande, U.S. Provisional Patent Application No. 63/557,965 (Attorney Docket No. C0655/41166), entitled “PARCEL ROUTE OPTIMIZER SYSTEM AND METHOD,” and filed Feb. 26, 2024, the entire contents of which are incorporated herein by reference.

### FIELD OF DISCLOSURE

The present subject matter relates to systems and methods for managing shipments of parcels and more particularly, a system and method to identify shipping routes of parcels from a warehouse to a destination.

### BACKGROUND

An operator of an online store may contract with a warehouse operator to fulfill delivery of goods or products sold via the online store. The warehouse operator may have a plurality of warehouses from which such goods and goods sold by other online stores may be shipped. The online store management system may periodically transmit to a warehouse management system a list of products sold and a destination address where each sold product is to be delivered. The warehouse operator (i.e., shipper) determines the warehouse from which the product is to be shipped and reserves space on one or more scheduled commercial/passenger flight(s) (i.e., carriers) via one or more airport(s) to deliver the product from a warehouse to a last mile delivery provider (e.g., the U.S. Postal Service, a courier service, etc.) associated with the destination address of the product. Various routes may be available between the warehouse to the last mile delivery provider. Some routes may be a direct route between a departure airport proximate the warehouse and a destination airport proximate the last mile delivery provider. Other routes may pass through one or more intermediary airports between the departure airport and the destination airport. Each such route may require a different amount of transit times between the departure and destination airports and have different costs associated therewith.

### SUMMARY

According to one aspect, a system to optimize routing of a plurality of shipments includes a computer-based device having one or more processors and a memory having instruction stored therein that cause the one or more processors to receive shipment data associated with the plurality of shipments. The shipment data includes at least an originating postal code and a destination postal code associated with each shipment. The one or more processors further identify a plurality of departure airports associated with each originating postal code, identify a plurality of destination airports associated with each destination postal code, and develop a first plurality of routes associated with the plurality of shipments. Each route is associated with a departure airport and a destination airport. In addition, the one or more processors develop a plurality of shipment counts, wherein each shipment count of the plurality of shipment counts is associated with a departure airport of the plurality of airports and indicates a quantity of the plurality routes that are associated with the departure airport. Further, the one or more processors select a shipment from the plurality of shipments, select a plurality of candidate routes from the plurality of routes that may be used for the shipment, select a route of the plurality of candidate routes associated with a departure airport having highest shipment count associated therewith, and assign the selected route to the shipment.

According to another aspect, a computer-based method to optimize routing of a plurality of shipments includes receiving shipment data associated with the plurality of shipments. The shipment data includes at least an originating postal code and a destination postal code associated with each shipment. The method further includes identifying a plurality of departure airports associated with each originating postal code, identifying a plurality of destination airports associated with each destination postal code, and developing a first plurality of routes associated with the plurality of shipments. Each route is associated with a departure airport and a destination airport. The method also includes developing a plurality of shipment counts, wherein each shipment count of the plurality of shipment counts is associated with a departure airport of the plurality of airports and indicates a quantity of the plurality routes that are associated with the departure airport. In addition, the method includes selecting a shipment from the plurality of shipments, selecting a plurality of candidate routes from the plurality of routes that may be used for the shipment, selecting a route of the candidate plurality of routes associated with a departure airport having highest shipment count associated therewith, and assigning the selected route to the shipment.

Other aspects and advantages will become apparent upon consideration of the following detailed description and the attached drawings wherein like numerals designate like structures throughout the specification.

### BRIEF DESCRIPTION OF THE DRAWINGS

FIG. 1 is a block diagram of parcel route optimization system of the present disclosure;

FIG. 2 is a block diagram of a computer device that may implement the parcel route optimization system of FIG. 1;

FIG. 3 is a process diagram showing steps undertaken by a data import module of the parcel route optimization system of FIG. 1;

FIG. 4, when joined along the lines A-A, comprises a process diagram showing steps undertaken by a route simulator of the parcel route optimization system of FIG. 1;

FIG. 5, when joined along the lines A-A, comprises a process diagram showing steps undertaken by a dynamic route configuration module of the parcel route optimization system of FIG. 1;

FIG. 6 is a process diagram showing steps undertaken by an airport recommendation engine of the parcel route optimization system of FIG. 1; and

FIG. 7 is a process diagram showing steps undertaken by a carrier rating module of the parcel route optimization system of FIG. 1.

### DETAILED DESCRIPTION

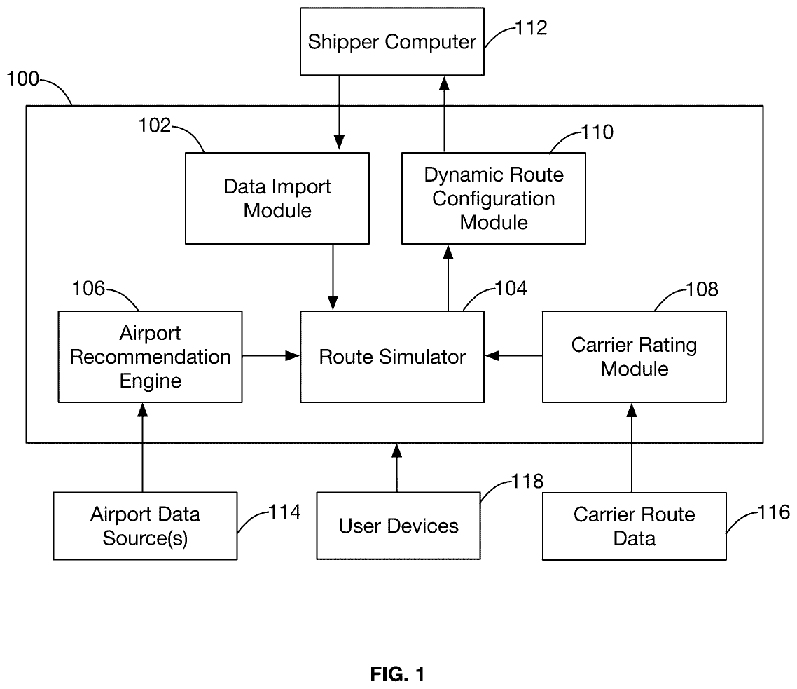

Referring to FIG. 1, disclosed herein is a parcel route optimization system (PROS) 100 that may be used by the warehouse operator (i.e., the shipper) to identify optimal routes for shipping a plurality of parcels from a plurality of origination locations to a plurality of recipients. The optimal routes use space available on commercial aircraft and analyze efficiencies in cost and time that may be available by selecting particular combinations of a plurality of long distance and short distance routes between the origination locations and destination locations proximate the recipients, and increasing a quantity of parcels shipped along each of the plurality routes to obtain discounts, and the like.

The PROS 100 receives a shipping data set that specifies a plurality of shipments (products) from a retailer or other seller (e.g., an online store, a physical store, a manufacture, and the like) to be fulfilled by a warehouse operator that maintains inventory of products and coordinates shipping of such products on behalf of the retailer or other seller. Note, in some cases, that the retailer or other seller may be identical to the warehouse operator or shipper. The PROS 100 analyzes the shipping data set to determine optimal routes on commercial aircraft for end-to-end delivery of the shipments from the warehouse operator to a last-mile delivery provider (e.g., the US Postal Service, a courier service, and the like), identifies the best routes and carriers, and develops an estimate of the cost of such delivery. The PROS 100 analyzes a plurality of combinations of routes with respect to various factors to automatically identify optimal routes for such shipments. For example, the PROS 100 may analyze a plurality of routes for the plurality of shipments, respectively, to identify routes that that would maximize the number of shipments using common routes. In addition, the PROS 100 may consider differences in carrier costs based on airports through which the shipment may be routed. For example, the warehouse may be proximate to plurality of departure airports, the last-mile delivery provider may be proximate to a plurality of destination airports, routing a shipment through an airport in Montana may be more expensive than routing the shipment through Denver International airport, and other factors may determine the optimal route for the shipment.

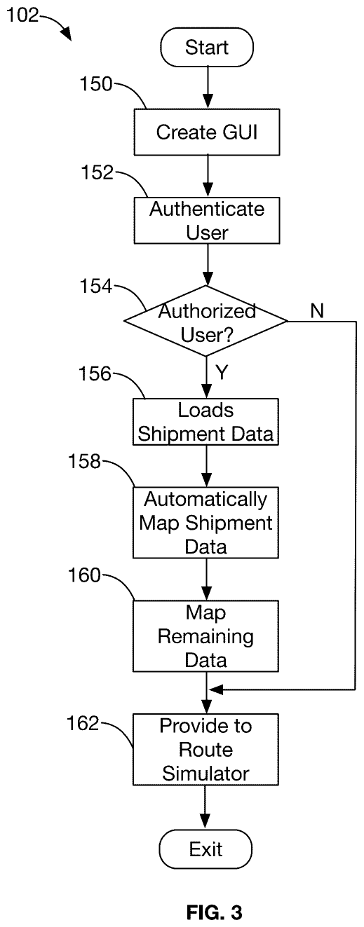

Continuing to refer to FIG. 1, the PROS 100 includes a data import module 102, a route simulator 104, an airport recommendation engine 106, a carrier rating module 108, and a dynamic route configuration module 110. As described in greater detail below in connection with FIGS. 3 through 7, the data import module 102 receives shipment data from a computer 112 associated with a shipper (i.e., the warehouse operator or an entity working on behalf the warehouse operator) that identifies a plurality of parcels to be shipped. The route simulator 104 receives the shipment data and cleanses such data (i.e., normalizes or standardizes zip codes, addresses, and the like). The route simulator 104 also develops airport information using the airport recommendation engine 106 and carrier information from the carrier rating module 108. The airport information identifies all airports and distances between each airport and each postal code and may be developed from public airport and postal code data sources 114 such as those provided by the Federal Aviation Administration, a national postal service, and the like. The carrier information includes information regarding carrier routes, ratings, and costs in accordance with data supplied by carrier route data sources 116 such as carrier operators, and the like.

Thereafter, the route simulator 104 develops a plurality of candidate long distance routes and last mile delivery routes for each shipment and develops a cost estimate for each route in accordance with the airport information and the carrier information. The dynamic route configuration module 110 analyzes the candidate route information developed by the route simulator 104 to select optimal routes for each shipment and develops an estimate of costs for the shipment of parcels in the shipping data received by the data import module 102 and provides such optimal route information and/or cost estimates to the shipper via, for example, the computer 112 associated therewith.

One or more components 102-108 of the PROS 100 may be also coupled to and responsive to one or more user device(s) 118 such as a keyboard, a mouse, a display, a touchscreen, a joystick, etc. via which an operator may monitor and direct operation of the PROS 100.

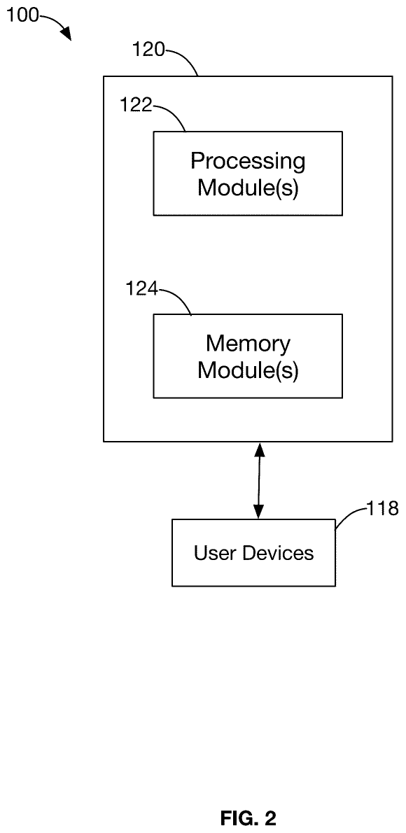

Referring to FIG. 2, the PROS 100 described herein may be implemented using hardware, software, firmware, or combinations thereof including one or more suitably programmed computer-based device(s) 120, some or each having one or more processing module(s) 122 and one or more memory module(s) 124. The memory 124 module(s) have stored therein, among other things, programming instructions executed by one or more processing module(s) 122 to cause the components of the PROS 100 to undertake the functions described herein.

Each computer-based device 120 may comprise, e.g., a computer, a device using one or more application specific integrated circuits (ASIC's) and/or field-programmable gate arrays (FPGA's), and/or combinations thereof. Such computer-based device 120 may be unitary or may be distributed multiple computing devices, and one or more such computing devices may be installed locally on or remote from other such computer-based devices 120. Each computer-based device 120 may communicate with another computing device over one or more network(s) such as a local area network (LAN), a cellular network, a wide area network (WAN) such as the Internet, and the like.

FIG. 3 shows the steps undertaken by the data import module 102 to load shipment data from the shipper computer into the PROS 100. At step 150, the data import module 102 causes the computer 112 used by the shipper to generate and display a graphical user interface (GUI) that allows a representative of the shipper to interact with the PROS 100. At step 152, the data import module 102 uses the GUI to request authentication credentials (e.g., username, password, and the like) from the representative and receives the authentication credentials. At step 154, the data import module 102 verifies the authentication credentials to confirm the representative is authorized to interact with the PROS 100 and proceeds to step 156. Otherwise, the data import module 102 exits.

At step 156, the data import module 102 allows the authorized user to use the GUI to supply one or more files having shipment data associated with shipment of a plurality of parcels to a plurality of destination addresses and the data import module 102 loads (i.e., reads) such files into the memory 124 (FIG. 2) of the PROS 100. In some cases, the shipment data may specify the shipment of 100,000 parcels or more. For each parcel, the shipment data includes data fields that specify a ship date, a sender postal code, a recipient postal code, a parcel weight, and a shipment index. The shipment index associated with a parcel may be a value that uniquely identifies such parcel within the shipment data (the shipment index may be otherwise termed a primary key). In addition, the shipment data may specify additional information for the parcel including, for example, a service type, parcel height, parcel length, parcel width, sender company, carrier, and meter cost. The service type may indicate a shipping service type (e.g., ground, expedited, and the like) used to route a comparable previously shipped parcel similar to the parcel (present parcel) with which such data is associated, carrier is the carrier that completed shipment of the previously shipped parcel, and meter cost is the cost for shipping the previously shipped parcel. In some embodiments, such information regarding the previously shipped parcel may be applied to select the service type and carrier to ship the present parcel.

In some embodiments, the shipment data may be, for example, a database table, a spreadsheet, a delimited data file, an XML file, and the like. The delimited data file may be, for example, a comma-separated data file, a tab-separated file, and the like. In some embodiments, the shipment data may comprise a plurality of rows and a plurality of columns, wherein each row (or predetermined number of rows) is associated with each parcel to be shipped and each column is associated with one of the data fields noted above.

In some embodiments, the shipment data may include a header row that includes, for each column, a user-provided identifier associated with the data represented in such column and such user-provided identifier may be used to map the data in the remaining rows to the data fields noted above. In other embodiments, a separate data file or data source may be provided that specifies a mapping between the contents of the shipment data and the data fields noted above.

In some embodiments, the data import module 102 associates each of the data fields noted above with predetermined field names used by the PROS 100. At step 158, the data import module 102 determines if any one or more of the user-provided identifiers supplied with the shipment data (e.g., in the header row(s), the separate file, etc.) are identical or sufficiently similar to the predetermined field names and automatically maps the content associated with such user-provided identifiers with corresponding predetermined field names. At step 160, the data import module 102 directs the GUI to prompt the authorized user to specify the predetermined field names to associate with content (e.g., columns) associated with user-provided identifiers that do not match any of the predetermined field names. Also at step 160, the data import module may undertake additional checks and/or data cleansing operations such as removing any information that may identify a person associated with the shipment, that the mapped data does not exceed predetermined file size limits, and the like. Undertaking steps 158 and 160 produces mapped shipment data having the shipment data provided by the shipper mapped to the predetermined field names.

Thereafter, at step 162, the data import module 102 provides the mapped shipment data to the route simulator 104 for processing. In some embodiments, the data import module 102 stores the mapped shipment data in an input queue associated with the route simulator 104. In other embodiments, the data import module 102 provides the mapped shipment data to an analyst who may invoke the route simulator 104 to process the mapped shipment data. The data import module 102 then exits.

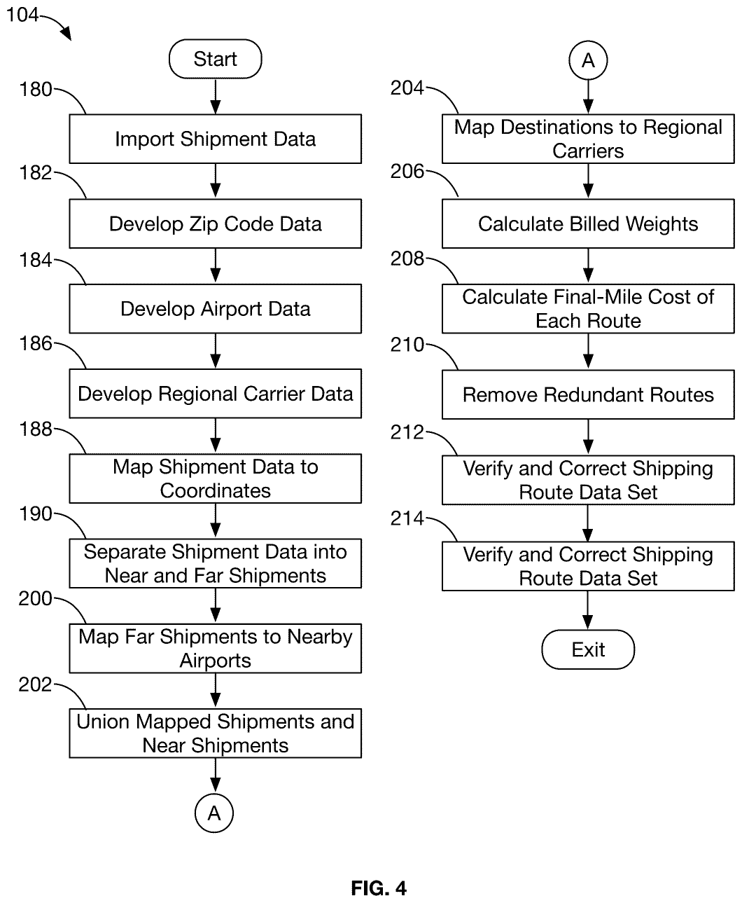

FIG. 4 shows the processing undertaken by the route simulator 104 to process the mapped shipment data. At step 180, the mapped shipment data are loaded. In particular, the route simulator 104 reads the mapped shipment data and applies one or more data cleaning algorithms including normalizing or standardizing data associated with the sender and receiver postal codes, normalizing data associated with carrier identifiers or names and service groups (i.e., service type identifiers associated with parcels), parcel dimensions, and the like.

At step 182, the route simulator 104 develops data representing a list of all postal codes that specify normalized location data such as, e.g., latitude and longitude, a city, and a state associated with each sender and recipient postal code. At step 184, the route simulator 104 uses the airport recommendation engine 106 to identify all airports that are within a predetermined radius from each postal code developed at step 182. In response, the airport recommendation engine 106 provides a distance from each airport to a predetermined location associated with each of the postal codes that are within the predetermined radius. In some embodiments, such predetermined radius is 300 miles. In other embodiments, the authorized user may use the GUI described above to specify such predetermined radius. Limiting the airports in accordance with the predetermined radius may reduce the number of route options that have to be considered by the PROS 100 and thereby improve computational efficiency.

At step 186, the route simulator 104 uses the carrier rating module 108 to identify postal codes that are served by regional final-mile carriers identified in the carrier field of the shipment data and final-mile costs information associated with such regional carriers.

At step 188, the route simulator 104 joins the mapped shipment data received at step 180 and the postal code data developed at step 182 to augment the mapped shipment data of each parcel represented therein with a sender normalized location, sender city, and sender state associated with the sender postal code and a recipient normalized location, recipient city, and recipient state associated with the recipient postal code.

At step 190, the route simulator 104 separates the augmented shipment data developed at step 188 into a long distance shipment data set and a short distance shipment data set. The long distance shipment data set includes those shipments having a distance between the sender postal code and the recipient postal code that is at least a predetermined shipping distance and short distance shipment data set includes those shipments that have a distance between the sender postal code and the recipient postal code that is less than the predetermined shipping distance. In some embodiments, such predetermined distance may be 300 miles. In other embodiments, the predetermined distance may be selected by the representative of the shipper or other authorized user of the PROS 100, for example, using the GUI discussed above.

At step 200, the route simulator 104 maps the long distance shipment data set to the airport data developed in step 184 to identify departure and destination airports that are proximate to the sender postal code and recipient postal code of each shipment specified in the long distance shipment data set and adds such information to the long distance shipment data set.

At step 202, the route simulator 104 develops a union of the long distance shipment data set developed at step 200 with the short distance shipment data set to produce a candidate shipping route data set that includes all possible departure airport and destination airport recommendations that are proximate to the sender postal code and destination postal code, respectively, for each shipment in the long distance and short distance shipping data sets. In this manner, long distance shipments have departure and destination airports associated therewith and short distance shipments that may be better served by ground-only carriers may not have departure and/or destination airports associated therewith. This allows the PROS 100 to balance costs, time-in-transit, and computational efficiency by eliminating high-cost air route options for short distance shipments.

Control proceeds from step 202 to step 204 as indicated by the designation A-A. At step 204, the candidate shipping route data set developed at step 202 is mapped to regional carrier service data in accordance with the destination postal code associated with each shipment to identify all candidate carriers (i.e., both long distance and short distance carriers) that serve the destination postal code and such information is added to the candidate shipping route data set.

At step 206, the route simulator 104 calculates a billed weight for each shipment represented in the candidate shipping route data set developed at step 204. In some embodiments, the billed weight is calculated in accordance with a dimensional (DIM) factor applied to a product of dimensions of the parcel associated with the shipment as would be understood by one who has ordinary skill in the art. Such billed weight is a basis used to calculate the transportation cost associated with the shipment. In some embodiments, such DIM factor is 194 inches. However, it should be apparent that a different DIM factor may be used in other embodiments. Further, such DIM factor may be varied in accordance with one or more carrier(s) associated with the route associated with the shipment.

At step 208, the route simulator 104 computes a final-mile cost for each combination of a shipment, route (either ground-based or airport-based), and regional carrier represented in the candidate shipping route data set. The final-mile cost is developed in accordance with rates associated with each regional carrier that may provide the final-mile delivery and may use a DIM factor associated with each regional carrier. Such final-mile cost information is added to the candidate shipping route data set.

At step 210, the route simulator 104 analyzes the candidate shipping route data set developed at step 208 and identifies and removes any overlapping (redundant) point-to-point routes between postal codes that are served by both a national carrier and at least one regional carrier and retains only those routes that are served by the at least one regional carrier. Thus, routes provided by a national carrier are retained only in those situations when no regional carrier serves such route. In some embodiments, the regional carriers are ground-based or final-mile carriers.

At step 212, the route simulator 104 analyzes the candidate shipping route data set developed at step 210 and verifies the accuracy of the data mapping steps undertaken to develop such data set. Further, the route simulator 104 confirms postal codes served by each regional carrier, detects fields containing invalid (e.g., null) values, identifies any routes that lack a departure or destination airport within the predetermined radius noted in connection with step 184, and the like. The route simulator 104 corrects any such issues and provides the candidate shipping route data set corrected in this manner to the dynamic route configuration module 110 at step 214. In some embodiments, the route simulator 104 copies the candidate shipping route data set into an input queue associated with the dynamic route configuration module 110. In other embodiments, the route simulator 104 provides the candidate shipping route data set to an analyst and the analyst invokes the dynamic route configuration module 110 with the supplied candidate shipping route data set.

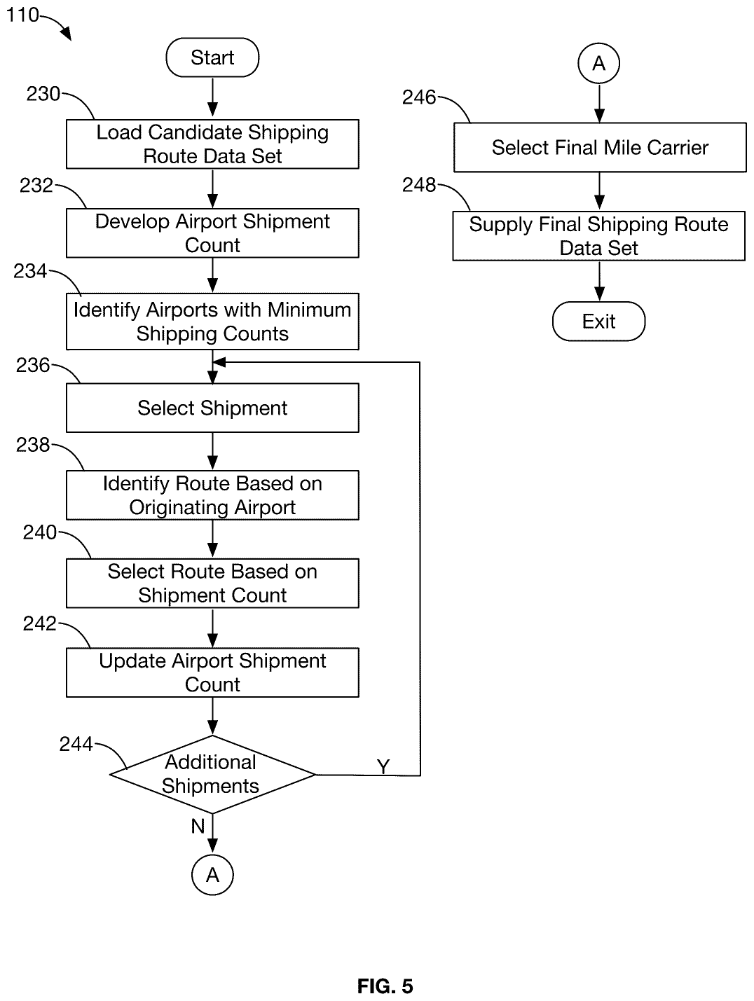

FIG. 5 shows the processing undertaken by the dynamic route configuration module 110. At step 230, the dynamic route configuration module 110 loads the candidate shipping route data set developed by the route simulator 104. At step 232, the dynamic route configuration module 110 develops a shipment count for each departure airport from which a route originates. The shipment count associated with the departure airport is a value that represents a number of routes associated with the shipments in the candidate shipping route data set that originate at such airport.

At step 234, the dynamic route configuration module 110 identifies those departure airports that have a shipment count that is at least a predetermined minimum shipment count. In some embodiments, the shipper may specify the predetermined minimum shipment count, for example, using the GUI discussed above.

At step 236, the dynamic route configuration module 110 selects one of the shipments represented in the candidate shipping route data set. At step 238, the dynamic route configuration module 110 identifies routes associated with the selected shipment that originate at a departure airport that is one of the airports identified at step 232 that is within the predetermined radius (see step 184, FIG. 4) of the sender postal code and are associated with destination airports that are within the predetermined radius of the destination postal code. At step 240, the dynamic route configuration module 110 selects a route for the selected shipment from the route(s) identified at step 236 that has the departure airport having the highest shipment count. If there are more than one routes that originate at different departure airports having the same highest shipment count, the dynamic route configuration module 110 selects the route associated with a destination airport closest to the destination postal code. At step 242, the dynamic route configuration module 110 reduces the shipment count of the departure airports associated with the unselected routes by one.

At step 244, the dynamic route configuration module 110 determines if there are any shipments remaining the candidate shipping route data set that have not been assigned a route and if so returns to step 232 to select another shipment.

Otherwise, control proceeds from step 244 to step 246 as indicated by the designation A-A. At step 246, the dynamic route configuration module 110 determines a final-mile carrier for each selected route in the candidate shipping route data set. In particular, if only a single final-mile carrier is available from a destination airport associated with a route and the destination postal code, such single final-mile carrier is assigned to the route. However, if there are multiple final-mile route carriers between the destination airport and the destination postal code, preferences of the shipper may be used to select the final-mile carrier. For example, the GUI of the PROS 100 may display a list of available final-mile carriers and the representative of the shipper may rank such available final-mile carriers from most preferred to least preferred.

At step 248, the dynamic route configuration module 110 develops a final shipping route data set that specifies the route and final-mile carrier selected for each shipment specified in the candidate shipping route data set. In some embodiments, the final shipping route data set may be provided to the shipper. In some embodiments, the final shipping route data set may be combined with rate information (i.e., shipping and handling fees, transportation fees, and the like) and revenue information associated with the shipper to determine projected revenues the shipper may realize from the retailer.

The steps undertaken by the dynamic route configuration module 110 ensures that departure airports with the highest throughput (i.e., volume of shipments for the shipper) are selected for routes, thereby possibly allowing the shipper to reduce overall shipment costs. Further, the shipper may adjust parameters such as the predetermined radius, predetermine minimum shipping counts, preferred airports, preferred carriers, airport coverage (i.e., a number of postal codes that lie within a predetermined distance of an airport), and the like to examine the effects of such parameters on the costs associated with shipping the parcels represented in the shipment data provided by the shipper.

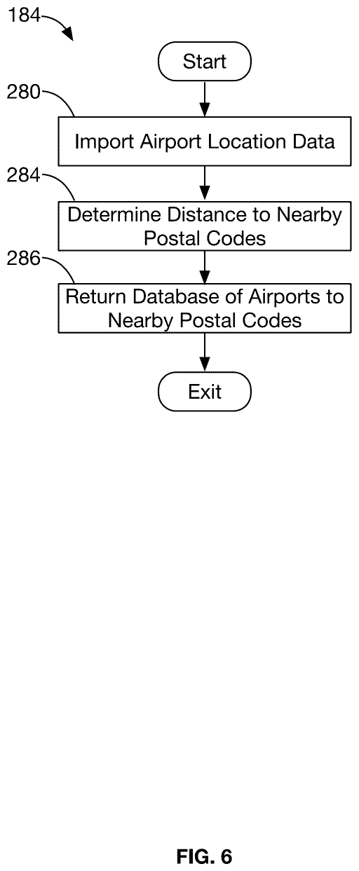

FIG. 6 shows the steps undertaken by the airport recommendation engine 106 at step 184 (FIG. 4) undertaken by the route simulator 104 to identify departure and destination airports that are within the predetermined radius of postal codes. At step 280, the airport recommendation engine 106 accesses one or more airport data sources 114 (such as a data source provided by the U.S. Federal Aviation Administration or another governmental body) and imports location data associated with airports in a region (e.g., the United States) served by the shipper. At step 284, the airport recommendation engine 106 determines the postal codes that are within the predetermined radius of each airport. At step 286, the airport recommendation engine 106 returns the airport-postal code information developed at step 284 and exits.

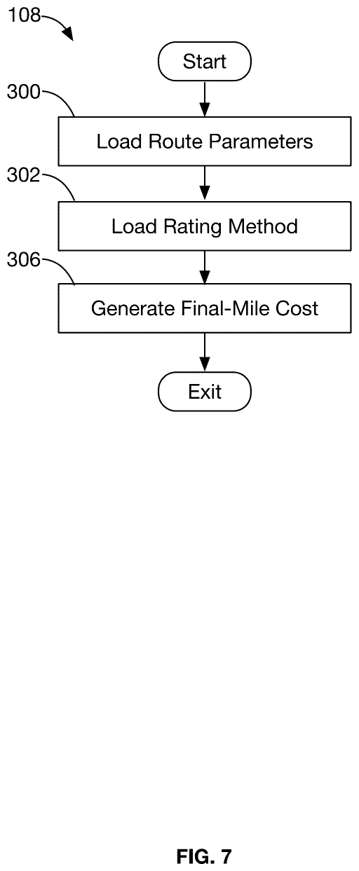

FIG. 7 shows the steps undertaken by the carrier rating module 108 at step 186 (FIG. 4) undertaken by the route simulator 104 to obtain final-mile carrier information. At step 300, the carrier rating module 108 loads routes (e.g., routes between airports and destination postal codes) served by a plurality of final-mile carriers from a carrier route data source 116. The plurality of final-mile carriers may include preferred final-mile carriers identified by the shipper (e.g., with the shipment data) and/or predetermined final-mile carriers associated with the PROS 100. At step 302, the carrier rating module 108 loads a rating method to be used with the plurality of final-mile carriers. Such rating method may be distances between postal codes served by the carrier, distance between airports and postal codes, and the like. At step 304, the carrier rating module 108 determines final-mile costs associated with the plurality of final-mail carriers and supplies such information to the route simulator 104. Such final cost may be developed in accordance with rates associated with the final-mile carrier, zones or distance of travel for the parcel, a weight of the parcel, and the like.

It should be apparent to those who have skill in the art that any combination of hardware and/or software may be used to implement components of the PROS 100 described herein. It will be understood and appreciated that one or more of the processes, sub-processes, and process steps described in connection with FIGS. 1-7 may be performed by hardware, software, or a combination of hardware and software on one or more electronic or digitally-controlled devices. The software may reside in a software memory 124 in a suitable electronic processing component or system such as, for example, one or more of the functional systems, controllers, devices, components, modules, or sub-modules depicted in FIGS. 1-7 The software memory 124 may include an ordered listing of executable instructions for implementing logical functions (that is, “logic” that may be implemented in digital form such as digital circuitry or source code, or in analog form such as analog source such as an analog electrical, sound, or video signal). The instructions may be executed within a processing module or controller (e.g., the data import module 102, the route simulator 104, the airport recommendation engine 106, the carrier rating module 108, and the dynamic route configuration module 110) which includes, for example, one or more microprocessors, general purpose processors, combinations of processors, digital signal processors (DSPs), field programmable gate arrays (FPGAs), application-specific integrated circuits (ASICs), and/or graphics processing units (GPUs). Further, the schematic diagrams describe a logical division of functions having physical (hardware and/or software) implementations that are not limited by architecture or the physical layout of the functions. The example systems described in this application may be implemented in a variety of configurations and operate as hardware/software components in a single hardware/software unit, or in separate hardware/software units.

While particular embodiments of the present invention have been illustrated and described, it would be apparent to those skilled in the art that various other changes and modifications can be made and are intended to fall within the spirit and scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

We claim:

1. A system to optimize routing of a plurality of shipments, comprising:
a computer-based device having one or more processors and a memory having instructions stored therein that cause the one or more processors to:
receive shipment data associated with the plurality of shipments, wherein the shipment data includes at least an originating postal code and a destination postal code associated with each shipment;
identify a plurality of departure airports associated with each originating postal code;
identify a plurality of destination airports associated with each destination postal code;
develop a first plurality of routes associated with the plurality of shipments, wherein each route is associated with a departure airport and a destination airport;
develop a plurality of shipment counts, wherein each shipment count of the plurality of shipment counts is associated with a departure airport of the plurality of airports and indicates a quantity of the plurality routes that are associated with the departure airport;
select a shipment from the plurality of shipments;
select a plurality of candidate routes from the plurality of routes that may be used for the shipment;
select a route of the plurality of candidate routes associated with a departure airport having highest shipment count associated therewith; and
assign the selected route to the shipment.

2. The system of claim 1, wherein the one or more processors further identify a carrier between the destination airport associated with the shipment and the postal code associated with the shipment.

3. The system of claim 1, wherein the one or more processors further associate a plurality of departure airports with each shipment of the plurality of shipments, wherein each of the plurality of departure airports associated with each shipment is within a predetermined distance of the originating postal code of such shipment.

4. The system of claim 3 wherein the one or more processors further associate a plurality of destination airports with each shipment of the plurality of shipments, wherein each of the plurality of destination airports associated with each shipment is within a predetermined distance of the destination postal code of such shipment.

5. The system of claim 1, wherein the one or more processors further separate the plurality of routes into long distance routes and short distance routes and associate a departure airport only with the long distance routes.

6. The system of claim 1, wherein a distance between a sending postal code and a destination postal code associated with each of the long distance routes is at least a predetermined shipping distance.

7. The system of claim 1, wherein the one or more processors further develop shipping cost information associated with each of the plurality of shipments.

8. The system of claim 1, wherein the one or processors develop a plurality of selected routes, wherein each of the plurality of selected routes is associated with a corresponding one of the plurality of shipments and is selected in accordance with one of the plurality of shipment counts.

9. The system of claim 1, wherein information regarding the plurality of selected routes is transmitted to a computer remote from the computer-based device.

10. A computer-based method to optimize routing of a plurality of shipments, comprising:
receiving shipment data associated with the plurality of shipments, wherein the shipment data includes at least an originating postal code and a destination postal code associated with each shipment;
identifying a plurality of departure airports associated with each originating postal code;
identifying a plurality of destination airports associated with each destination postal code;
developing a first plurality of routes associated with the plurality of shipments, wherein each route is associated with a departure airport and a destination airport;
developing a plurality of shipment counts, wherein each shipment count of the plurality of shipment counts is associated with a departure airport of the plurality of airports and indicates a quantity of the plurality routes that are associated with the departure airport;
selecting a shipment from the plurality of shipments;
selecting a plurality of candidate routes from the plurality of routes that may be used for the shipment;
selecting a route of the candidate plurality of routes associated with a departure airport having highest shipment count associated therewith; and
assigning the selected route to the shipment.

11. The method of claim 10, wherein further including identify a carrier between the destination airport associated with the shipment and the postal code associated with the shipment.

12. The method of claim 10, further including associating a plurality of departure airports with each shipment of the plurality of shipments, wherein each of the plurality of departure airports associated with each shipment is within a predetermined distance of the originating postal code of such shipment.

13. The method of claim 12, further including associated a plurality of destination airports with each shipment of the plurality of shipments, wherein each of the plurality of destination airports associated with each shipment is within a predetermined distance of the destination postal code of such shipment.

14. The method of claim 10, wherein further including separate the plurality of routes into long distance routes and short distance routes and associating a departure airport only with the long distance routes.

15. The method of claim 14, wherein a distance between a sending postal code and a destination postal code associated with each of the long distance routes is at least a predetermined shipping distance.

16. The method of claim 10, further including developing shipping cost information associated with each of the plurality of shipments.

17. The method of claim 10, further including developing a plurality of selected routes, wherein each of the plurality of selected routes is associated with a corresponding one of the plurality of shipments and is selected in accordance with one of the plurality of shipment counts.

18. The method of claim 10, further including transmitting information regarding the plurality of selected routes to a remote computer remote.
